(19) United States
(12) Patent Application Publication
(10) Pub. No.: US 2024/0195140 A1
(43) Pub. Date: Jun. 13, 2024

(54) Methods And Apparatus To Generate Macroscopic Fock And Other Sub-Poissonian States Of Radiation

(71) Applicant: Massachusetts Institute of Technology, Cambridge, MA (US)

(72) Inventors: Marin Soljacic, Belmont, MA (US); Nicholas Rivera, Somerville, MA (US); Jamison Sloan, Somerville, MA (US); Yannick Salamin, Arlington, MA (US)

(21) Appl. No.: 18/286,790

(22) PCT Filed: Apr. 12, 2022
(86) PCT No.: PCT/US2022/024400

§ 371 Date: Oct. 13, 2023

Related U.S. Application Data
(60) Provisional application No. 63/177,548, filed on Apr. 21, 2021.
(60) Provisional application No. 63/271,952, filed on Oct. 26, 2021.
(60) Provisional application No. 63/311,605, filed on Feb. 18, 2022.

(51) Int. Cl. H01S 3/109; B82Y 20/00; G02F 1/35; H01S 3/16

(52) U.S. Cl. CPC H01S 3/109; G02F 1/354; H01S 3/1611; H01S 3/1643; B82Y 20/00

(57) ABSTRACT

A principle which enables the generation of macroscopic Fock and sub-Poissonian states is disclosed. Generic components of the system include: an electromagnetic structure (possessing one or more electromagnetic resonances), a nonlinear electromagnetic element (such as a nonlinear crystal near or inside the structure), and a source of light. In one embodiment, stimulated gain is used to create large numbers of photons in a cavity, but with very low photon number noise (uncertainty) in the cavity, and thus acts as a Fock laser. This Fock laser is capable of producing these states due to a very sharp intensity-dependent gain (or loss) that selects a particular photon number. The disclosed system and method are robust against both atomic and optical decoherence. Various examples of the new Fock laser design are also described.

This application claims priority to U.S. Provisional Patent Application Ser. No. 63/177,548, filed Apr. 21, 2021; U.S. Provisional Patent Application Ser. No. 63/271,952, filed Oct. 26, 2021 and U.S. Provisional Patent Application Ser. No. 63/311,605, filed Feb. 18, 2022, the disclosures of which are incorporated by reference in their entireties.

This invention was made with Government support under Grant No. FA9550-20-1-0115 awarded by the Air Force Office of Scientific Research, and under Grant No. W911NF-18-2-0048 awarded by the Army Research Office. The Government has certain rights in the invention.

### FIELD

Apparatus for the generation of sub-Poissonian and Fock states of radiation at optical frequencies are disclosed.

### BACKGROUND

Macroscopic quantum states of light remain among the most important goals of quantum science and engineering. One specific example that is of interest is number (or Fock) states of light. Number (or Fock) states of light, are of great interest for both fundamental science and quantum technologies. However, the generation and stabilization of large-number Fock states remains a long-standing open problem. A single mode Fock state, being an energy eigenstate of the radiation field, is the most basic state of light. Such states, having exactly defined numbers of photons, are in high demand for applications in quantum spectroscopy, metrology, and communication. Large-number Fock states will allow sensitive quantum spectroscopies with minimal noise, yet have sufficient intensity to provide observable signal, and even access nonlinear optical phenomena. They are considered important both as means to store quantum information, and as elements for optical quantum computing. They are also a workhorse state, allowing more complex states to be built from them, as shown recently for the case of two-photon states. Such states are also useful for bosonic quantum computation, in which the logical element is a quantum harmonic oscillator, as such a low loss microwave (superconducting) cavity. Numerous other applications could also be enabled by Fock states. In each case, the Fock state can be used to perform quantum simulation in fields such as quantum chemistry, where roto-vibrational spectra of molecules can be calculated.

Fock states are also, by their nature, very challenging to generate, let alone stabilize. Part of the reason Fock states are difficult to generate is that very few interactions between light and matter naturally select Fock states, as there is typically no mechanism selecting a particular photon number. Relatedly, they are also very fragile, often destabilizing at a rate proportional to the number of photons. For example, loss introduces photon number uncertainty into a cavity Fock state, as it is not known when a photon is lost. If one attempted to restore the state using gain, or instead attempted to amplify a small Fock state, the photon number uncertainty would again increase, as it is not known when a photon is emitted.

Many approaches to generating Fock states have been investigated theoretically and experimentally. For example, a Fock state can be built up transiently, before cavity losses set in, as has been demonstrated in state-of-the-art coherent-control experiments. This has led to approximate Fock states at microwave frequencies of roughly 10 photons (a record). A few other exciting schemes, applied at microwave frequencies, include the “micromaser” and quantum feedback protocols. At optical frequencies, one-photon Fock states can be produced by quantum emitters, while two-photon states can be produced by spontaneous parametric down-conversion. Fock states of more than two photons are exceedingly hard to generate at optical frequencies. There is also the related idea of sub-Poissonian lasing, where interference leads to reduced intensity noise in the far-field over some spectral bandwidth. Non-deterministic methods—where the resultant Fock state will be of a priori unknown number—include direct measurement (e.g., collapsing the wave function into a particular Fock state), and also includes quantum non-demolition measurements.

Therefore, it would be beneficial if there were a system and method that is capable of generating Fock or sub-Poissonian states of radiation. Further, it would be advantageous if this can be achieved at optical frequencies.

### SUMMARY

A principle which enables the generation of macroscopic Fock and sub-Poissonian states is disclosed. Generic components of the system include: an electromagnetic structure (possessing one or more electromagnetic resonances), a nonlinear electromagnetic element (such as a nonlinear crystal near or inside the structure), and a source of light. In one embodiment, stimulated gain is used to create large numbers of photons in a cavity, but with very low photon number noise (uncertainty) in the cavity, and thus acts as a Fock laser. This Fock laser is capable of producing these states due to a very sharp intensity-dependent gain (or loss) that selects a particular photon number. The disclosed system and method are robust against both atomic and optical decoherence. Various examples of the new Fock laser design are also described.

According to one embodiment, an apparatus for the generation of sub-Poissonian states of radiation at optical and infrared frequencies is disclosed. The apparatus comprises a pump; a gain medium; and a cavity; wherein apparatus exhibits a sharp frequency dependent gain or loss. In certain embodiments, the apparatus comprises an absorbing medium, which absorbs strongly at optical or infrared frequencies, wherein the gain medium, the absorbing medium, or the cavity exhibits a sharp frequency dependent gain or loss. In some embodiments, the gain medium comprises one or more of the following:
a. a solid-state gain medium (such as YAG, YAP, LuAG, YVO₄, KGW with Nd, Er, Tm, Yb, or other rare-earth dopants), Ti:Sapphire, Ruby
b. a gain medium based on a semiconductor such as GaAs, AlGaAs, GaInAsP, InP, InGaAs, GaN or one or multiple quantum wells
c. a gain medium based on quantum dots
d. a gain medium based on dyes such as rhodamine-6G; and
e. gases such as He—Ne mixtures or CO₂.

In some embodiments, the cavity comprises a nonlinear cavity. In certain embodiments, wherein the nonlinear cavity comprises a cavity formed by two mirrors, the two mirrors having any geometry (e.g., a planar Fabry-Perot cavity, a confocal or semi-confocal cavity, a spherical or hemi-spherical cavity, or an unstable resonator). In certain embodiments, the sharp frequency dependent loss is realized by an optical filter. In certain embodiments, the optical filter comprises at least one of notch, edge, band-pass filters or more general filter shapes that may be realized based on thin films, coupled resonances, Fano resonances, (surface and volume) diffraction (Bragg) gratings, fiber gratings, and bistable optical systems. In some embodiments, a sharpness of the optical filter at some frequency, ω, is at least 1 part in 10², 10³, 10⁴, 10⁵, or 10⁶, wherein the sharpness is defined as Δω/ω, where Δω is defined as a frequency deviation from ω required for a transmission of the optical filter to double. In some embodiments, the cavity comprises a nonlinear energy spectrum. In certain embodiments, the nonlinear energy spectrum is realized by inserting a Kerr nonlinear medium into the cavity. In certain embodiments, the Kerr nonlinear medium comprises GaAs, Ge, ZnTe (and general semiconductors), Si, Si₃N₄, GaP, silica, chalcogenide glasses such as As₂S₃ or As₂Se₃, nonlinear gases such as CS₂, saturable absorbing media (such as Cr:YAG), or polymers such as PTS or DDMEBT. In some embodiments, the nonlinear energy spectrum is realized by inserting fifth-, seventh-, or higher-order nonlinear medium into the cavity. In some embodiments, the nonlinear energy spectrum is realized by the nonlinear coupling excitons to a cavity in the strong coupling regime, where the exciton-cavity coupling exceeds the dissipation rates of the exciton and cavity separately. In some embodiments, the nonlinear energy spectrum is realized by coupling two levels of a quantum system, such as an atom or molecule or artificial atom such as a quantum dot or quantum well, to the cavity such that the coupling is in the dispersive strong-coupling regime, such that the detuning of the quantum system and cavity is larger than their dissipation rates. In some embodiments, the gain medium exhibits the sharp frequency dependent gain. In some embodiments, a semiconductor or insulating material is placed in the cavity, wherein the semiconductor or insulating material is operated near the band-edge to create the sharp frequency dependent gain. In some embodiments, a nonlinear crystal is disposed within the cavity, wherein the nonlinear crystal in conjunction with the gain medium together realize an effectively sharp gain. In some embodiments, at least one frequency dependent mirror is disposed in the cavity, wherein the frequency dependent mirror causes the cavity to exhibit a sharp frequency dependent loss.

According to another embodiment, an apparatus for the generation of sub-Poissonian states of radiation at optical and infrared frequencies is disclosed. The apparatus comprises a cavity; and a source of pump radiation to populate the cavity with an initial number of photons; wherein apparatus exhibits a sharp frequency dependent gain or loss. In some embodiments, the apparatus comprises an absorbing medium, which absorbs strongly at optical or infrared frequencies, wherein the absorbing medium, or the cavity exhibits a sharp frequency dependent gain or loss. In some embodiments, the cavity comprises a nonlinear cavity. In some embodiments, the nonlinear cavity comprises a cavity formed by two mirrors, the two mirrors having any geometry (e.g., a planar Fabry-Perot cavity, a confocal or semi-confocal cavity, a spherical or hemi-spherical cavity, or an unstable resonator). In certain embodiments, the sharp frequency dependent loss is realized by an optical filter. In certain embodiments, the optical filter comprises at least one of notch, edge, band-pass filters or more general filter shapes that may be realized based on thin films, coupled resonances, Fano resonances, (surface and volume) diffraction (Bragg) gratings, fiber gratings, and bistable optical systems. In certain embodiments, a sharpness of the optical filter at some frequency, ω, is at least 1 part in 10², 10³, 10⁴, 10⁵, or 10⁶, wherein the sharpness is defined as Δω/ω, where Δω is defined as a frequency deviation from ω required for a transmission of the optical filter to double. In some embodiments, the cavity comprises a nonlinear energy spectrum. In certain embodiments, the nonlinear energy spectrum is realized by inserting a Kerr nonlinear medium into the cavity. In certain embodiments, the Kerr nonlinear medium comprises GaAs, Ge, ZnTe (and general semiconductors), Si, Si₃N₄, GaP, silica, chalcogenide glasses such as As₂S₃ or As₂Se₃, nonlinear gases such as CS₂, saturable absorbing media (such as Cr:YAG), or polymers such as PTS or DDMEBT. In some embodiments, the nonlinear energy spectrum is realized by inserting fifth-, seventh-, or higher-order nonlinear medium into the cavity. In some embodiments, the nonlinear energy spectrum is realized by the nonlinear coupling excitons to a cavity in the strong coupling regime, where the exciton-cavity coupling exceeds the dissipation rates of the exciton and cavity separately. In some embodiments, the nonlinear energy spectrum is realized by coupling two levels of a quantum system, such as an atom or molecule or artificial atom such as a quantum dot or quantum well, to the cavity such that the coupling is in the dispersive strong-coupling regime, such that the detuning of the quantum system and cavity is larger than their dissipation rates. In some embodiments, a semiconductor or insulating material is placed in the cavity, wherein the semiconductor or insulating material is operated near the band-edge to create the sharp frequency dependent gain. In some embodiments, at least one frequency dependent mirror is disposed in the cavity, wherein the frequency dependent mirror causes the cavity to exhibit a sharp frequency dependent loss. In some embodiments, the apparatus exhibits a sharp frequency dependent loss and no gain. In some embodiments, the apparatus exhibits a sharp frequency dependent loss and a non-frequency dependent gain.

### BRIEF DESCRIPTION OF THE DRAWINGS

For a better understanding of the present disclosure, reference is made to the accompanying drawings, in which like elements are referenced with like numerals, and in which:

FIG. 1 is a chart showing the performance of a Fock laser in terms of two parameters;

FIG. 2A shows a general schematic of a Fock laser;

FIG. 2B shows uneven spaced energy levels within the cavity;

FIG. 2C shows gain and loss with different configurations;

FIG. 3A shows a schematic of the Kerr laser, which consists of a cavity with a source of third-order nonlinearity, and an embedded gain medium based on two active lasing levels;

FIG. 3B shows intensity-dependent gain and loss wherein the gain is on resonance with the bare cavity and blue-detuned from the cavity;

FIG. 3C shows steady-state intensity and its fluctuations as a function of pump intensity for different detuning of gain;

FIG. 3D shows the nature of bistability for a Kerr laser;

FIGS. 4A-4K show a pumped gain medium and a third-order nonlinear crystal embedded in a cavity and various embodiments of the frequency dependent mirror;

FIGS. 4L-4P illustrate other embodiments showing how optical Fock and sub-Poissonian cavity states can be realized based on the general concept;

FIG. 5 shows gain and absorption losses for a gain medium embedded in a confocal cavity with one frequency independent mirror and one mirror with a Fano resonance;

FIG. 6A shows the transmission of a notch filter as a function of wavelength;

FIG. 6B shows the emission and absorption rates for a mirror-notch cavity;

FIGS. 7A-7D show photon noise condensation in systems with sharply non-linear loss, as realized by an anharmonic oscillator with sharply frequency-dependent loss;

FIGS. 8A-8E shows transient noise condensation and production of Fock and macroscopic sub-Poissonian states of light;

FIGS. 9A-9E shows the results when a different set of parameters are used with the system shown in FIG. 8A;

FIGS. 10A-10I show the results when a different set of parameters are used with the system shown in FIG. 2A; and

FIGS. 11A-11E show a Fock laser and the results when a different set of parameters are used with this laser.

### DETAILED DESCRIPTION

A new fundamental principle which can enable generation of macroscopic quantum states of light is disclosed. This principle may be used to generate large-number Fock states of the electromagnetic field (acting thus as a laser of Fock states or a “Fock laser”). In this disclosure, the term “Fock laser” is used to describe an apparatus that creates Fock states, or sub-Poissonian states of radiation at either optical or microwave frequencies. In certain embodiments, the term “Fock maser” is used to explicitly connote an apparatus that produces sub-Poissonian or Fock states at microwave frequencies.

First, definitions of sharp dependence of gain and loss and important figures of merit and quantities that can define the performance of the proposed devices are provided. A measure of sub-Poissonian light and Fock states (the latter being a special case of the former) is the Fano factor,

$$F = \frac{{( Δ n )}^{2}}{〈 n 〉} \geq 0 ,$$

where [symbol] n [symbol] is the mean number of photons in the cavity (structure) and Δn is the uncertainty in the photon number. Coherent states of light, and more generally Poissonian distributions of photon number, have F=1. Sub-Poissonian states of light have F<1 and Fock states, being maximally sub-Poissonian, have F=0. Noise reduction corresponds to F<1, and so statements of the form 99% noise reduction refer for example to F=0.01. In all of the Fock laser embodiments, it is the case that this Fano factor can be calculated from knowledge of the mean photon number, as well as the ratio of the intensity-dependent stimulated emission rate Gₙ and loss rate Lₙ (n is photon number or intensity). It can be determined that the uncertainty

$$Δ n = {( \frac{{G}_{n + 1}}{{L}_{n + 1}} - 1 )}^{- 1 / 2} .$$

Based on this, it follows that:

F=( [symbol] n [symbol] (1− [symbol] / [symbol] ))⁻¹.

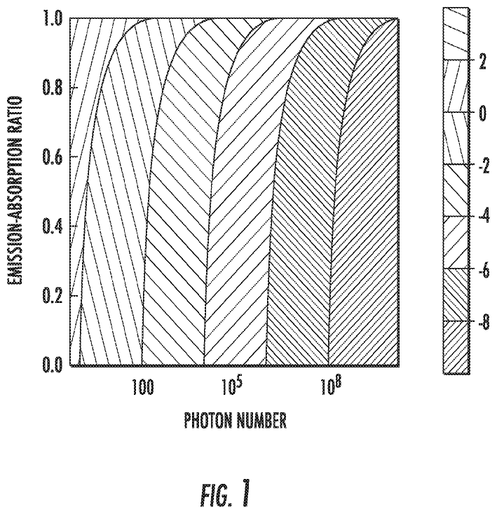

In FIG. 1, the Fano factor is plotted as a function of the intracavity photon number and the “emission-absorption ratio” [symbol] / [symbol] . This ratio is somewhat analogous to the derivative of the gain-loss-ratio, taken at the steady-state operating point. Contours show different performances for different parameter regimes. A value of “0” means no noise reduction, while a value of “−2” means 99% noise reduction, and a value of “−4” means 99.99% noise reduction. As an example of the plot: for an intracavity photon number of 10³ and an emission-absorption ratio of 0.9 (10% change in gain and/or loss when photon number is changed by 1), the noise reduction is 99%.

The mean photon number also follows from the gain and loss-rates, satisfying the equation [symbol] = [symbol] . It may be envisaged that for a given laser device, the power (giving the intracavity photon number), and enough properties of the gain and loss to determine the gain and loss rates as a function of intensity may be measured, and thus any laser mode can be evaluated according to FIG. 1.

Based on the definition of Fano factor, systems may be designed that create devices with very low Fano factors. For example, a sharp gain may significantly affect the Fano factor. Note that F=( [symbol] n [symbol] (1− [symbol] / [symbol] ))⁻¹. For the case of sharp gain, the following equation, [symbol] = [symbol] +Δ [symbol] , may be used to describe the gain, while it is noted that [symbol] ≈ [symbol] . Since [symbol] = [symbol] , the Fano factor may be expressed as F=( [symbol] n [symbol] ×(− [symbol] / [symbol] ))⁻¹. Thus, for a fractional change in gain |Δ [symbol] / [symbol] | (“sharpness of gain”) of 10⁻⁸ and [symbol] n [symbol] =10⁴, 10⁸, 2×10⁸, 10¹⁰, 10¹², Fano factors of 10⁴, 1, 0.5, 0.01, 10⁻⁴, respectively are obtained. Alternative values of (−Δ [symbol] / [symbol] ) are readily accommodated by this formula. For example, “sharp gain” may be defined as |Δ [symbol] / [symbol] |>10⁻⁸. In certain embodiments, “sharp gain” may be defined as |Δ [symbol] / [symbol] |>10⁻⁴. In other embodiments, “sharp gain” may be defined as |Δ [symbol] / [symbol] |>10⁻².

Similarly, sharp loss may also significantly affect the Fano factor. For the case of sharp loss, defining [symbol] =L+Δ [symbol] and noting [symbol] ≈ [symbol] , leads to=( [symbol] n [symbol] ×(ΔL/ [symbol] ))⁻¹. Thus, for a fractional change in loss Δ [symbol] / [symbol] (“sharpness of loss”) of 10⁻⁸ and [symbol] n [symbol] =10⁴, 10⁸, 2×10⁸, 10¹⁰, 10¹², Fano factors of 10⁴, 1, 0.5, 0.01, 10⁻⁴, respectively, are obtained. Alternative values of (Δ [symbol] / [symbol] ) are readily accommodated by this formula. For example, “sharp loss” may be defined as |Δ [symbol] / [symbol] |>10⁻⁸. In certain embodiments, “sharp loss” may be defined as |Δ [symbol] / [symbol] |>10⁻⁴. In other embodiments, “sharp loss” may be defined as |Δ [symbol] / [symbol] |>10⁻².

Thus, by creating a structure with a sharp gain or a sharp loss, a Fock laser may be created.

An embodiment of this structure is shown in FIG. 2A. The Fock laser comprises a cavity 12, gain medium 11, and pump 10. The cavity 12 hosts a mode of the EM field, which behaves as a single quantum harmonic oscillator. If the gain medium 11 provides gain at frequency ω, coinciding with that of the cavity 12, it will resonantly excite the cavity 12 (by stimulated emission) from a state with n photons to a state with n+1 photons. If the gain is off-resonance, then stimulated emission is ineffective at giving energy to the EM field.

Importantly, if the cavity 12 is nonlinear, so that the energy difference between n and n+1 photons is intensity-dependent, then the gain may become less resonant, and thus saturate, as the EM field gains energy. Now, imagine that a nonlinearity turns the cavity 12 into a “suddenly anharmonic oscillator” which has evenly-spaced energies ℏω, up to a critical excitation level n_{crit}, after which, the next transition (to n_{crit}+1) is very different in frequency from ℏω, as shown in FIG. 2B. It follows that beyond a sufficiently high pump, the system, in its steady state, will be “stuck” with photon numbers near n_{crit} as it cannot exceed this value, leading to a distribution strongly resembling a Fock state. The key effect is that the stimulated emission rate has been made sharply dependent on intensity. This may happen by having a very high-order nonlinearity (e.g., a nonlinearity with its lowest order being for example fifth-, seventh- or higher order). It may also happen (as is relevant for embodiments at optical frequencies) by coupling a low-order (e.g., third-order nonlinearity) to a cavity 12 whose gain or loss has a sharp frequency dependence. The nonlinearity transforms a sharp frequency dependence of the gain or loss into a sharp photon-number or intensity-dependence of the gain or loss. This effect is called spectral-statistical coupling.

FIG. 2C shows several examples of gain and loss. The leftmost graph shows a saturable gain 16 and loss 17 corresponding to a conventional laser based on a two-level gain medium leading to a photon number 18 having Poissonian statistics well-above threshold. The center graph shows sharply varying gain 16 and linear loss 17, leading to a sharp reduction of photon number 18 uncertainty, for pumping well above threshold. The right graph is similar to the middle graph, except with linear gain 16 and sharply varying loss 17.

This arrangement of components, produces inside the laser cavity, a Fock state with many photons in it, or a close approximate of a Fock state such as a macroscopic sub-Poissonian state. With the addition of another element for gain-switching or Q-switching, this laser can produce macroscopic pulses of light with a well-defined number of photons, referred to as a “Fock pulse”. In particular, by means of an ultrafast temporal modulation of the gain, such as by synchronously pumping the gain medium with an additional pulsed laser, the gain can be abruptly shut off, forcing the cavity Fock state to decay into the far field, becoming a far-field Fock pulse. Similarly, by ultrafast modulation of the loss, either actively, with electro-optic elements, or passively, with saturable absorbers, the loss can be abruptly increased, causing the cavity Fock state to leak out into a far-field Fock pulse.

As noted above, Fock states may also be generated at optical frequencies. At infrared and optical frequencies, this may be realized in a variety of ways.

A resonator (or cavity) may be coupled to a gain medium and a nonlinear medium (such as a third-order nonlinear medium presenting Kerr nonlinearity (self-phase modulation in a single-mode setting). Examples of the Fock laser are presented below. In certain embodiments, the resonator may be, for example, a Fabry-Perot cavity, a confocal or semi-confocal, or other type of mirror-cavity, a photonic crystal resonance mode, a whispering gallery mode, or other localized optical mode. There is no a priori restriction on whether the cavity is wavelength-scale or macroscopic. In the case of optical or infrared frequencies, the term “cavity” represents any system having at least one resonance in the optical or infrared range.

It may be the case that either the gain medium or the cavity transmission exhibits a sharp frequency dependence, such that, in the former case, the stimulated emission rate exhibits a sharp intensity dependence, or in the latter case, the cavity leakage rate or the internal absorption rate in the case of an absorber exhibits a sharp intensity dependence.

Regarding the absorber, the absorber corresponds to a material inside the laser cavity that strongly absorbs at optical or infrared frequencies. For a sufficiently sharp absorption (in frequency), the loss will become sharply intensity-dependent in the presence of a nonlinearity. For example, consider an absorber whose absorption has Lorentzian frequency-dependence centered at frequency ω₀ with width Γ. In the presence of a Kerr nonlinear medium where the resonator frequency depends on intensity as ωₙ=ω(1+2βn), the loss Lₙ associated with the absorption takes the form

$${L}_{n} ∼ \frac{α n}{1 + {[ ω ( 1 + 2 β n ) - {ω}_{0} ]}^{2} / {Γ}^{2}} .$$

An example of an absorber would be a gas, a molecular dye, or a solid with an allowed optical or infrared transition at the cavity frequency. The absorption can also occur through two-photon absorption (as in the case of a semiconductor such as GaAs supporting two-photon absorption of infrared radiation).

The intensity dependence follows from the frequency dependence due to the Kerr nonlinearity through an effect described as spectral-statistical coupling.

Thus, referring to FIG. 2A, the Fock laser comprises a pump 10, a gain medium 11 and a cavity 12, wherein the gain medium 11 and/or the cavity 12 comprises a gain or loss that exhibits a sharp frequency or intensity dependence.

This may be achieved in a multitude of ways.

For example, this may be realized by having a gain medium with a sharp gain, such as that associated with a gas laser, or a solid-state gain medium such as Nd:YAG.

In other embodiments, the gain medium may comprise:
A solid-state gain medium (such as YAG, YAP, LuAG, YVO₄, KGW with Nd, Er, Tm, Yb, or other rare-earth dopants), Ti:Sapphire, Ruby
A gain medium based on a semiconductor such as GaAs, AlGaAs, GaInAsP, InP, InGaAs, GaN or one or multiple quantum wells
A gain medium based on quantum dots
A gain medium based on dyes such as rhodamine-6G
Gases such as He—Ne mixtures or CO₂.

Alternatively, this may be also realized by having a cavity with a sharp frequency-dependent transmission, such as by having one of the cavity mirrors with a sharp frequency-dependent transmission. This may be achieved by having a mirror hosting one or more internal resonance modes to provide it with a Lorentzian, Fano, or more complex spectrum (such as that associated with a notch, edge, laser-line, or other type of filter). In this case, there are no particular requirements on the gain-medium besides providing enough gain to achieve lasing, as well as being sufficiently narrow relative to the cavity free-spectral mode to provide single-mode lasing. Thus, gain media that may be used include gaseous media, molecular dyes, and solid-state media such as Nd:YAG, Nd:YVO₄, Ti:Sapphire, or semiconductors. It may also include quantum wells, quantum dots, perovskites, and quantum cascade laser gain media.

In another embodiment, sharp frequency-dependent transmission may also be realized by coupling the cavity to an optically bistable cavity with a very sharp output power characteristic.

Thus, the cavity with a sharp frequency-dependent transmission may be realized in a number of different ways, including:
A cavity formed by two mirrors, of any geometry (e.g., a planar Fabry-Perot cavity, a confocal or semi-confocal cavity, a spherical or hemi-spherical cavity, or an unstable resonator);
A cavity formed by means of one frequency-independent mirror and one frequency-dependent mirror (e.g., a source of sharp-frequency dependent loss);
A ring resonator;
A 1D or 2D photonic crystal resonance mode (supporting general resonances including Fano resonances and bound states in the continuum); and
A localized mode formed at a defect in a 1D, 2D, or 3D photonic crystal.

In another embodiment, this may also be realized by having the internal loss be sharply frequency-dependent, such as a system with a Lorentzian absorption spectrum, or operating near the band-edge of a semiconductor or insulating material which is placed in the cavity. The phrase “operating near the band-edge” is defined such that the laser frequency is slightly below the band-gap of the semiconductor or insulator, such as 1 part in 1000; 1 part in 10,000; 1 part in 100,000; or 1 part in 1,000,000. In this case, there are no particular requirements on the gain-medium besides providing enough gain to achieve lasing, as well as being sufficiently narrow relative to the cavity free-spectral mode to provide single-mode lasing. Thus, gain media that may be used include gas media, molecular dyes, and solid-state media such as Nd:YAG or semiconductors.

The sharp frequency-dependent loss may be realized by an optical filter. The optical filter may comprise notch, edge, band-pass filters and more general filter shapes that may be realized based on thin films, coupled resonances, Fano resonances, (surface and volume) diffraction (Bragg) gratings, fiber gratings, bistable optical systems, or other realizations. The sharpness of the filter at some frequency, ω, is at least 1 part in 10², 10³, 10⁴, 10⁵, or 10⁶, wherein the sharpness is defined as Δω/ω, where Δω defined as the frequency deviation from ω required for the transmission of the filter to double. In this paragraph, the phrase “at least” is used to denote anything that is sharper than the recited values. In other words, 1 part is 10⁷ is included in all of the above.

The nonlinearity should provide self-phase modulation and thus should generally be of odd order (such as third-order) and may be provided by conventional third-order nonlinear media with strong nonlinearities such as GaAs, Si, Si₃N₄, chalcogenide glasses, or polymers. Nonlinearity may also be created by means of strongly-coupled systems such as exciton polaritons with strong nonlinearities arising from Coulomb interactions, or systems exhibiting electromagnetically induced transparency, which display an exceptionally strong effective Kerr nonlinearity.

The excitons may be coupled to the cavity in the strong coupling regime, where the exciton-cavity coupling exceeds the dissipation rates of the exciton and cavity separately.

In another embodiment, two levels of a quantum system (such as an atom or molecule or artificial atom such as a quantum dot or quantum well) may be coupled to a cavity such that the coupling is in the dispersive strong-coupling regime, such that the detuning of the quantum system and cavity is larger than their dissipation rates.

Beyond these effects, the noise reduction can be in principle further enhanced by using a “regular pump” with sub-Poissonian pump statistics, such as electrons in a space-charge-limited tube (Coulomb repulsion creates the sub-Poissonian statistics), or current-regulated electrons in LEDS.

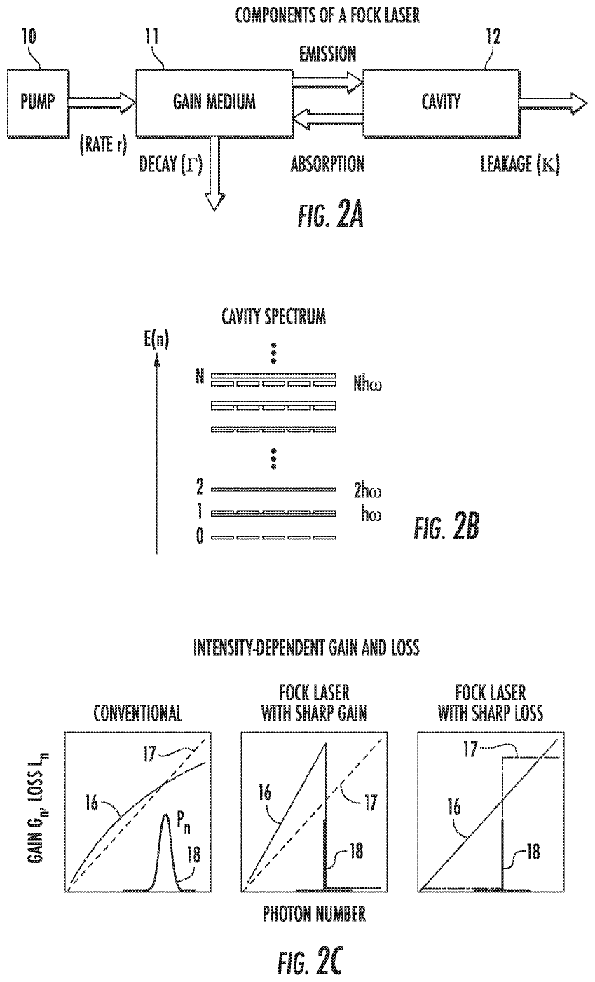

Consider the situation in FIG. 3A in which a gain medium 30 is coupled to a cavity 31 with a third-order nonlinear crystal 32 inside of it. In that case, for a single mode, the cavity Hamiltonian may be written as H_{cav}=ℏω((1−β)a†a−β(a†a)²). Here, β is a dimensionless nonlinear coupling constant, given in terms of the third-order susceptibility tensor, χ⁽³⁾ and the (real-valued) cavity mode eigenfunction F(r).

Next, consider the gain medium 30 is coupled to this Kerr cavity. To realize the maximal effect, the gain medium 30 should be detuned from the cavity 31 (at zero intensity), so that ω₀≠ω. The resulting gain is plotted in FIG. 3B, for gain 33 which is on resonance with the cavity (at zero intensity) and for gain 34 which is blue-detuned from the cavity 31. In the resonant case, the gain 33 increases roughly linearly for small photon number (as expected from stimulated emission). It then decreases for large enough intensity, because the photon frequency has increased (by 2βωn) and is now off resonance with the gain. In the detuned case, the gain maximizes at the intensity for which the (Kerr-shifted) cavity frequency becomes resonant with the gain transition. In other words, if the gain 34 is detuned from the cavity (at zero intensity), then the zero-intensity gain is quite weak. However, for a sufficiently high intensity, the cavity 31 will blue-shift to be on resonance with the gain medium 30, and the resulting gain 34 can be well-above threshold, leading to a steady state with finite intensity. Loss 35 is also plotted in FIG. 3B.

Next, the statistics of this “Kerr laser” will be described. The resulting mean photon number and uncertainty are shown in FIG. 3C for various detunings. FIG. 3C shows steady-state intensity and its fluctuations as a function of pump intensity for different detunings of the gain. The pump intensity is normalized to the threshold at zero detuning. The gain linewidth is taken to be Γ=10⁻⁴ω. Shaded regions denote regions where there are two steady-states for each detuning: the intensity corresponding to the steady-state with finite intensity is plotted. Larger detunings increase the maximum photon number, in accordance with FIG. 3B, but do not change the fluctuations, leading to larger noise reduction, as shown in the top right of FIG. 3C.

As the detuning is changed, the mean photon number in the cavity increases, as shown in FIG. 3C, where the laser output characteristics as a function of pump are plotted. The pump strength is normalized to the threshold in the case of resonant gain. Quantifying it, it can be seen that the expected number of photons, according to the condition Gₙ/Lₙ=1 is given by [symbol] n [symbol] =[δ+Γ\sqrt{α−1}]/2βω while the uncertainty is given as

$$Δ n = {( \frac{{G}_{n + 1}}{{L}_{n + 1}} - 1 )}^{- 1 / 2} .$$

This somewhat counter-intuitive behavior makes sense, as for larger detunings, it takes a larger photon number for the cavity to become resonant with the gain medium. Intriguingly, uncertainty in the photon number does not change, and so the probability distribution propagates without spreading as the detuning increases. This also corresponds to a reduction in the noise, compared to the shot noise limit, for a cavity field with the same mean photon number. In FIG. 3C, the maximum noise reduction is 86% of the shot-noise limit, with corresponding quantum statistics 36 shown below, compared against a coherent state 37. In the case of no detuning, the maximum noise reduction achievable is 50%, and occurs only for pump intensities far above threshold (e.g., fifty times), consistently with earlier theoretical work on lasers with embedded nonlinear media.

It may seem strange that further increasing the detuning, to a point where the gain is far off-resonance with the cavity, could lead to a better result. However, this does not come for free. In FIG. 3D, the two lowest eigenvalues of the rate matrix describing the lasing process are plotted. For large pump strengths, there is clearly only one steady state, and it is the near-Fock state 39 with sharply reduced noise. However, once the pump is sufficiently low, the two lowest eigenvalues become comparable (and both appear to be numerically zero). One of the two states has very low intensity, and is effectively a thermal state 38, while the other is the near-Fock state 39. In this “bistable” regime, the observed cavity state at long times depends sensitively on the initial conditions. For example, if the cavity 31 starts in the vacuum state when the pump is turned on, the system will rapidly converge to the thermal state 38, in accord with intuition that a highly detuned system should not lead to the production of many photons. The same result is observed even in situations where the initial cavity state is a coherent state, provided that the initial intensity is sufficiently low, as seen in FIG. 3D, bottom left. However, if the initial intensity is high enough, as in FIG. 3D, bottom right, the system will instead evolve toward the near-Fock state of FIG. 3C (bottom right). This is still of interest, because this provides a way to take light initially with shot noise and reduce it considerably to a near-Fock state, for large enough detuning, or large enough nonlinearity β.

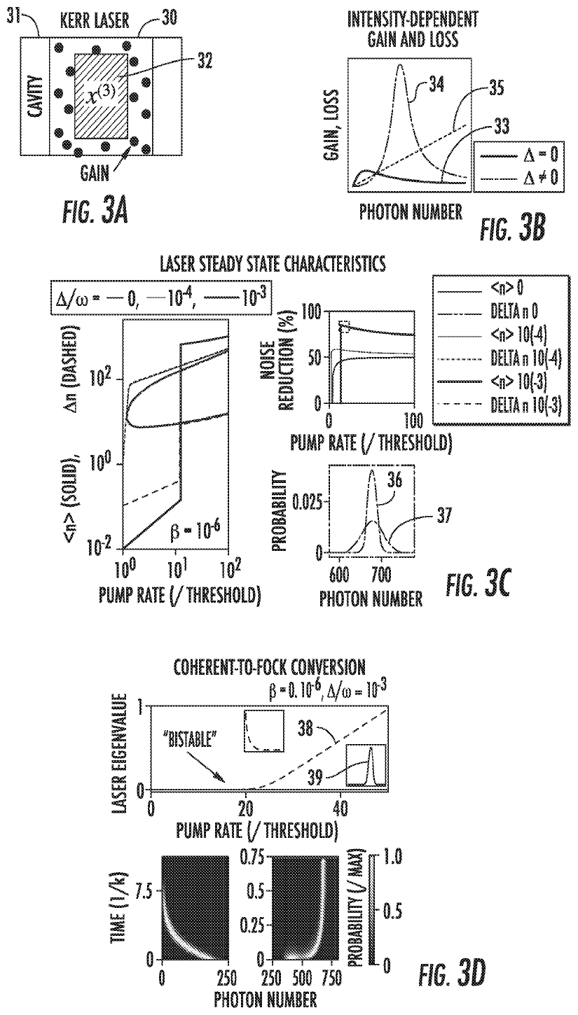

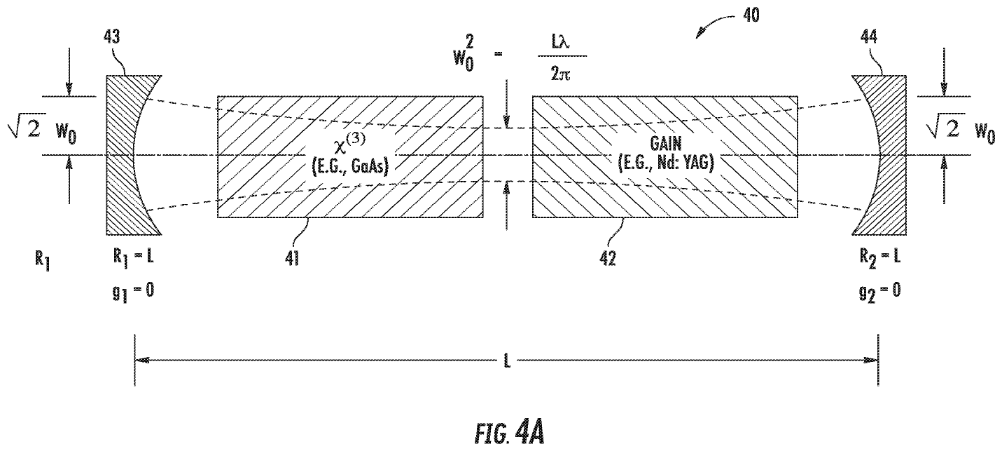

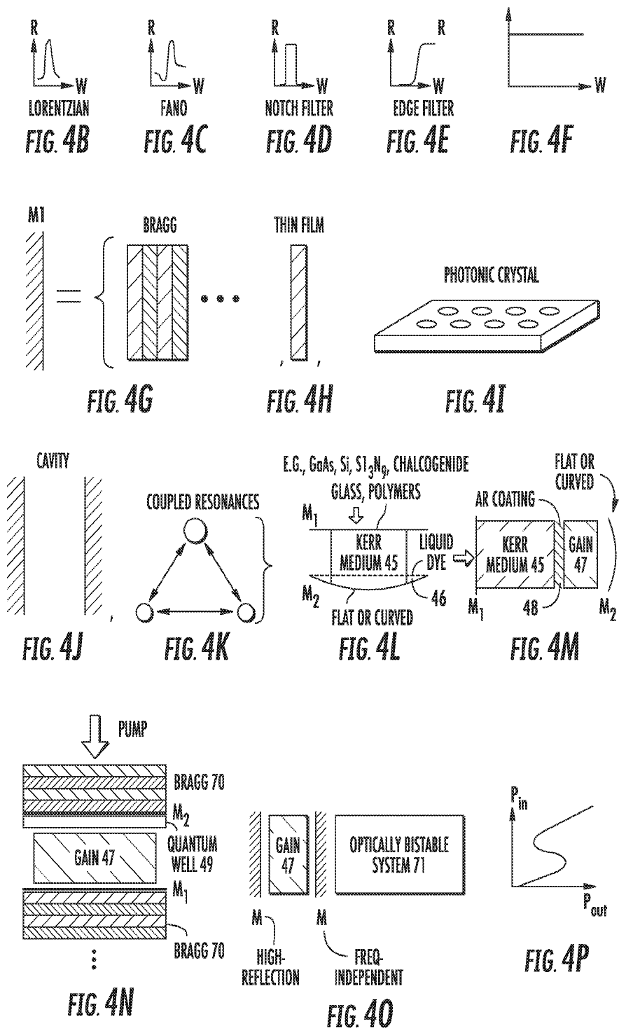

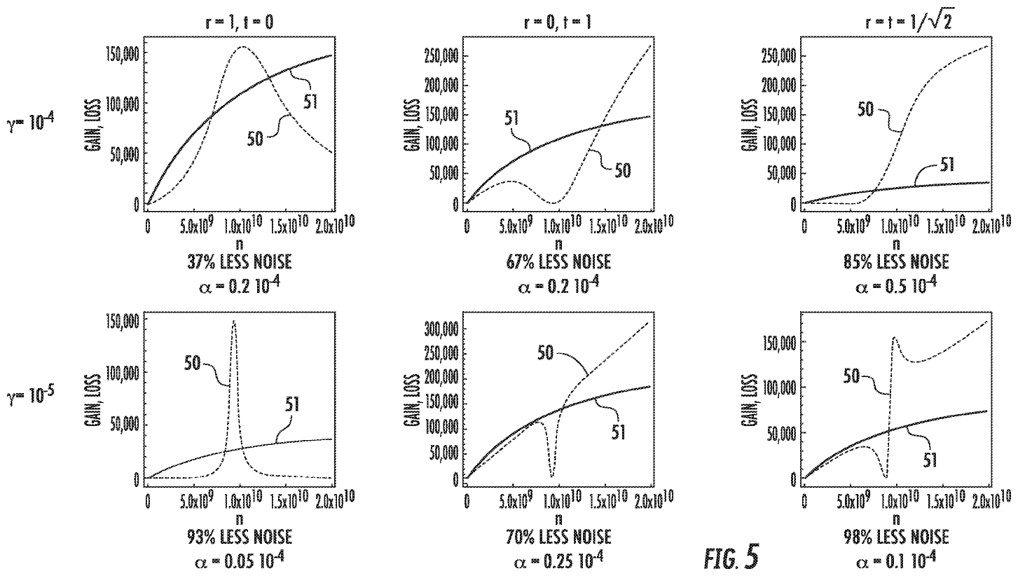

Another way to achieve the Fock lasing effect is to have cavity losses which sharply depend on frequency (whilst also having an embedded nonlinear medium). This is illustrated in FIG. 4A. A cavity 40, such as but not limited to a confocal cavity, is shown. A nonlinear medium 41, such as a third-order nonlinear medium and a gain medium 42 are embedded in the cavity 40. Mirrors are disposed on both ends of the cavity 40.

The primary difference of this geometry from that shown in FIG. 3A, where the optical gain is sharply photon-number dependent, is the presence of a sharply frequency-dependent mirror on one or both sides of the cavity 40. The sharp frequency-dependence of the mirror transmission (cavity loss) translates into a sharp dependence of the cavity loss-rate through the spectral-statistical coupling effect described above. The mirror 43 can be constructed in many ways provided that its transmission depends sharply on frequency. For concreteness, the discussion is restricted to the case in which one mirror 44 is frequency-independent, and the other is a frequency-dependent mirror 43. This frequency-dependent mirror 43 can be constructed for example to have a sharp Lorentzian spectrum (FIG. 4B), a Fano spectrum (FIG. 4C), or a more complex transmission spectrum (e.g., that associated with a notch filter as in FIG. 4D or an edge mirror as in FIG. 4E) achieved by having the mirror be composed of several internal resonances. Further, the flat frequency response of the frequency independent mirror 44 is also shown in FIG. 4F. Further, the frequency dependent mirror 43 may be constructed as a Bragg mirror as shown in FIG. 4G, a thin film as shown in FIG. 4H, a photonic crystal as shown in FIG. 4I, a cavity as shown in FIG. 4J or as multiple coupled cavity resonances as shown in FIG. 4K.

FIGS. 4L-4N show several other embodiments of how Fock and sub-Poissonian cavity states may be realized based on this concept. FIG. 4L shows a cavity bounded by two mirrors, at least one of which is a frequency dependent mirror. A Kerr medium 45, which is a non-linear element, is embedded in the cavity. The Kerr medium 45 may be various materials, such as but not limited to GaAs, Ge, ZnTe (and general semiconductors), Si, Si₃N₄, GaP, silica, chalcogenide glasses such as As₂S₃ or As₂Se₃, nonlinear gases such as CS₂, saturable absorbing media (such as Cr:YAG), or polymers such as PTS or DDMEBT.

A liquid dye 46, which serves as the gain medium, may be disposed within the cavity as well. One of the mirrors, such as M1, has a frequency dependent transmission, leading to frequency-dependent losses.

FIG. 4M shows a cavity bounded by two mirrors, at least one of which is a frequency dependent mirror, such as mirror M1. A Kerr medium 45, such as GaAs, Si, Si₃N₄, chalcogenide glass, or polymers, is embedded in the cavity. A gain medium 47 is also embedded in the cavity. An antireflective coating 48 is disposed between the Kerr medium 45 and the gain medium 47 to avoid stray reflection that would negatively impact the performance of the laser in the event that the Kerr medium 45 and the gain medium 47 have different indices of refraction.

FIG. 4N shows a cavity bounded by two mirrors, at least one of which is a frequency dependent mirror. Bragg filters 70 may be disposed on the outside surface of the mirrors. Within the cavity is a gain element 47 and a quantum well 49. The nonlinearity and resonator are provided by the combination of the quantum well 49 and the Bragg mirrors M1 and M2 (the alternating highlighting represents a Bragg mirror 70 with a periodic index of refraction), somewhat similar to the superconducting qubit case.

FIG. 4O shows a gain element 47 disposed between two mirrors. The frequency dependent mirror of the previous embodiments has been replaced by an optically bistable system 71 which has a very sharp dependence of its transmission on intensity. FIG. 4P shows a graph of the transmission of the optically bistable system 71 as a function of input power.

Examples of Lorentzian and Fano spectra are shown in FIG. 5, while examples associated with a notch filter spectrum are shown in FIG. 6.

In FIG. 5, one example of an embodiment involving Nd:YAG gain coupled to a frequency-dependent mirror with a single internal resonance mode is shown. In these figures, r and t are the “direct” reflection and transmission coefficients of the Fano mirror, respectively. The term “α” denotes the product βnₛ where nₛ is the saturation photon number. These may be considered as parameters which govern the shape of the transmission as a function of frequency. Gamma is the width of the internal resonance of the Fano mirror and determines the sharpness of the loss with frequency. Depending on the direct transmission coefficient (that which describes the light in the cavity directly escaping the cavity), the associated transmission spectrum can have a Lorentzian shape, or a Fano shape. Combined with a third-order nonlinearity which induced self-phase modulation, this leads to a dependence of the cavity loss rate on intensity shown in FIG. 5, where lines 50 represent absorption losses and lines 51 represent gain. Combined with the saturated gain of the Nd:YAG medium, which leads to the intensity dependence of the stimulated emission rate shown in lines 51, up to 98% percent noise reduction with billions of photons in the cavity mode for readily achievable cavity sharpnesses can be achieved. Even sharper cavities, as can be achieved with high-quality notch filters, or very sharp photonic crystal resonances, lead to even sharper noise reductions, approaching the limit of a truly macroscopic optical Fock state of a cavity mode.

FIGS. 6A-6B show a similar effect, but using the transmission associated with a notch filter, and a dye (Rhodamine-6G) as the gain medium. FIG. 6A shows the transmission of the notch filter as a function of wavelength. FIG. 6B shows the gain 52 and absorption loss 53 as a function of frequency. This results in sharp noise reduction and high extracavity power—leading to macroscopic states of radiation.

The following discusses valuable parameters for realizing Fock and macroscopically sub-Poissonian lasing. The gain is specified by the photon-number-dependent stimulated emission rates

$${G}_{n} = \frac{A n}{1 + \frac{n}{{n}_{s}} + \frac{4 {Δ}^{2}}{{Γ}^{2}}}$$

while the loss is specified as

$${L}_{n} = \frac{{v}_{g}}{2 l} T ( {ω}_{n + 1} - {ω}_{n} ) .$$

For a system with Kerr nonlinearity, this becomes

$${L}_{n} = \frac{{v}_{g}}{2 l} T ( {ω}_{00} ( 1 - 2 β n ) )$$

with ω₀₀ representing the bare cavity frequency and β representing the nonlinearity per photon.

Consider one numerical example where the gain medium is Nd:YAG, placed between two mirrors in a semi-confocal arrangement, for which the distance between the mirrors is 1.5 mm, and the radius of curvature of the curved mirror is 10 cm. With Nd:YAG (pumped to achieve a small signal gain of 10 cm⁻¹) and GaAs included, such that the nonlinearity per photon is β=4×10⁻¹⁷. With a reflection peak detuned from the cavity mode by δ=0.1 GHZ and a FWHM γ of 10⁻⁵, the resulting noise reduction is roughly 90% with an output power of 0.6 W. With β=10⁻¹⁶, γ=10⁻⁴ and δ=1.3 GHz, a similar result is achieved. Further, for β=10⁻¹⁴, γ=10⁻³ and δ=30 GHz, a similar result is achieved.

Note that the embodiments described above are simply specific examples of the configuration shown in FIG. 2A. In other words, the mirror cavity and sharp mirror embodiments are just particular realizations of the more general condition of “nonlinear cavity with sharp loss” described above. While the embodiments discussed in these paragraphs make use of mirror cavities as the feedback system, a general device need not. For example, a system based on an optical nanolaser is also appropriate and realizes stronger nonlinearities per photon.

Generally speaking, for nonlinearities arising from conventional materials such as GaAs, Si, or chalcogenide glasses (all with strong nonlinearities), polymers, or molecules, then for macroscopic cavities (lengths over 1 mm), values of β from 10⁻¹⁸ to 10⁻¹³ can be readily achieved. For very sharp systems, conventional systems such as silica may also be used. For the stronger nonlinearities in this range, transmission full-width-at-half-maxima (FWHM), γ, sharper than 10⁻² may be used (with the detuning δ of the reflection peak and cavity frequency being adjusted according to the precise value of β and γ, as in the example of the previous paragraph.) For the smallest nonlinearities in this range, γ<10⁻⁵ with appropriate detunings may be used. For systems with stronger nonlinearities, such as exciton polaritonic systems, strongly coupled systems, and EIT systems, values of β of 10⁻³ and below are achievable, in which case, FWHMs γ<10⁻¹ may be used. Regarding gain media, other gain media such as organic molecules (dyes), semiconductors, and perovskites may be used. For the strongest nonlinearites considered, gaseous gain media (e.g. HeNe, CO₂) may also be used. As an example of a case with stronger nonlinearities, consider a case where β=10⁻⁶ (at 1 eV), γ=2×10⁻⁵ and δ=1 THz. Taking the gain as a linear (unsaturated) gain with a small signal gain of 2 cm⁻¹, the noise reduction can be 99.9%, corresponding to a state with 2500 photons in the cavity and an uncertainty of 2. Another important possibility is using materials whose linear and/or nonlinear absorption increases rapidly, as in a gas such as CS₂.

The “nonlinear cavity with sharp loss” may also be used to generate Fock and sub-Poissonian states of optical radiation in the absence of a gain medium, using essentially the effect discussed in FIG. 3D with sharp gain: where it was noted that a Fock or sub-Poissonian (near-Fock) state could be generated by having a non-zero initial intensity in the cavity. In the sharp loss case, when there is an initial intensity in the cavity, under certain conditions, the decay of the cavity light (through leaking out of the cavity) will cause a Poissonian state to approach a near-Fock state, due to natural evolution of the photon probability distribution under the action of a sharp loss (the equations governing this evolution are the same as those describing the Fock laser, but without the gain terms).

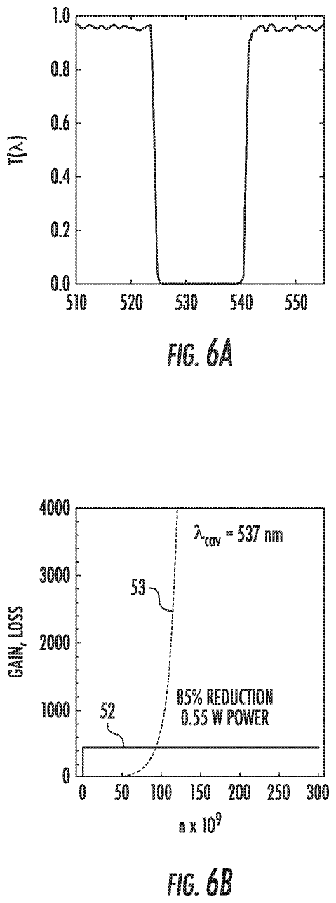

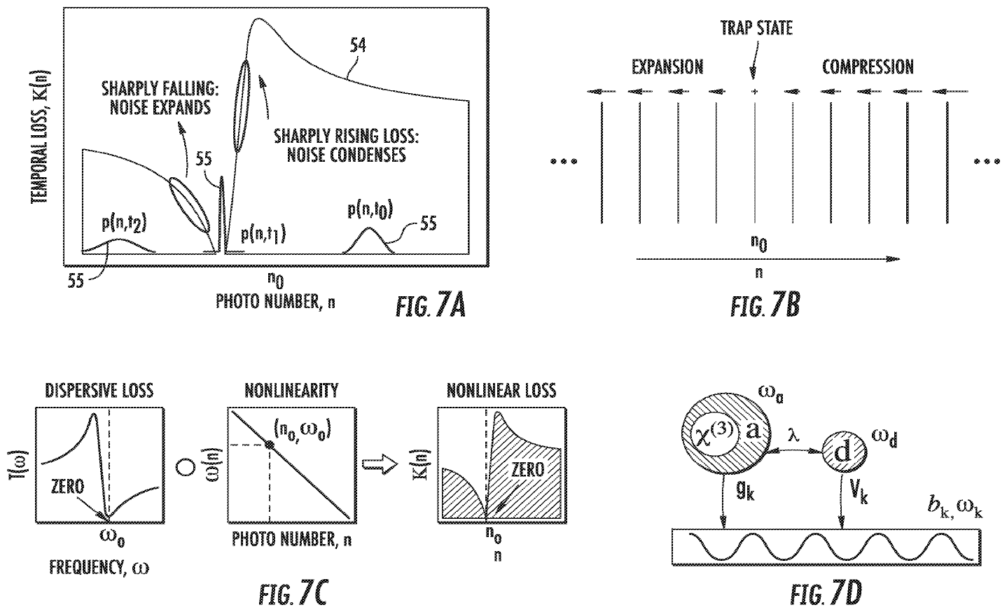

This is illustrated in FIG. 7A, which shows the quantum dispersion of photon probabilities in the presence of sharp loss. Thus, as shown in FIG. 7A, a nonlinear resonance where the loss rate 54 depends on photon number will have its photon number fluctuations compress as it decays, if it falls through a region of sharply rising loss. This is represented by the temporal evolution of the photon probability distribution 55 for different times, where t₀<t₁<t₂. P(n, t₀) represents an initially Poissonian distribution, p(n, t₁) represents a sub-Poissonian distribution and p(n, t₂) represents a super-Poissonian distribution. An initial probability distribution p(n, t₀) as it moves to lower photon numbers due to losses, will expand when it moves through a region of falling losses (noise increases), and condense as it moves through a region of increasing losses (noise decreases).

If the loss has a zero for some photon number no, the noise condensation is perfect and the system approaches a Fock state of no photons. This can be understood through the η-dependent transition from η to η−1 photons, shown in FIG. 7B, wherein the arrows denote magnitudes and the lines denote state on the Fock ladder. The gradient of the rates dictates the compression, expansion or trapping of the distribution.

FIG. 7C illustrates that nonlinear loss may be understood as arising from a composition of a frequency-dependent loss and an intensity-dependent cavity resonance frequency, such as due to Kerr nonlinearity.

FIG. 7D shows an exemplary system that could realize a loss in the form shown in FIG. 7A. This figure shows two resonances (a and d) coupled to a common continuum, in which one of the resonances (d) is linear and the other is nonlinear (a). A zero surrounded by a region of sharp losses arises due to destructive Fano interference between two leakage pathways for the non-linear resonance, which can become perfect for a precise number of photons in the non-linear resonance.

Unlike the case with a gain medium (the Fock laser), it is not possible to generate a Fock state if there is an insufficient intensity already present in the cavity. In particular, if there is a local minimum in the intensity-dependent loss, as pictured in FIG. 7A, then the initial intensity in the cavity needs to be above this local minimum in order for a near-Fock state to be generated. The initial number of photons may be populated using a source of pump radiation. The value of the photon number in the cavity will coincide with this local minimum, and the Fano factor will be below 1. The Fano factor will tend to zero (exact Fock state) when the local minimum coincides with a zero of the intensity-dependent loss. Unlike the cases above (with a gain medium), the state is short-lived: in the presence of even a small amount of residual linear losses, the near-Fock state will eventually decay further, and become Poissonian eventually.

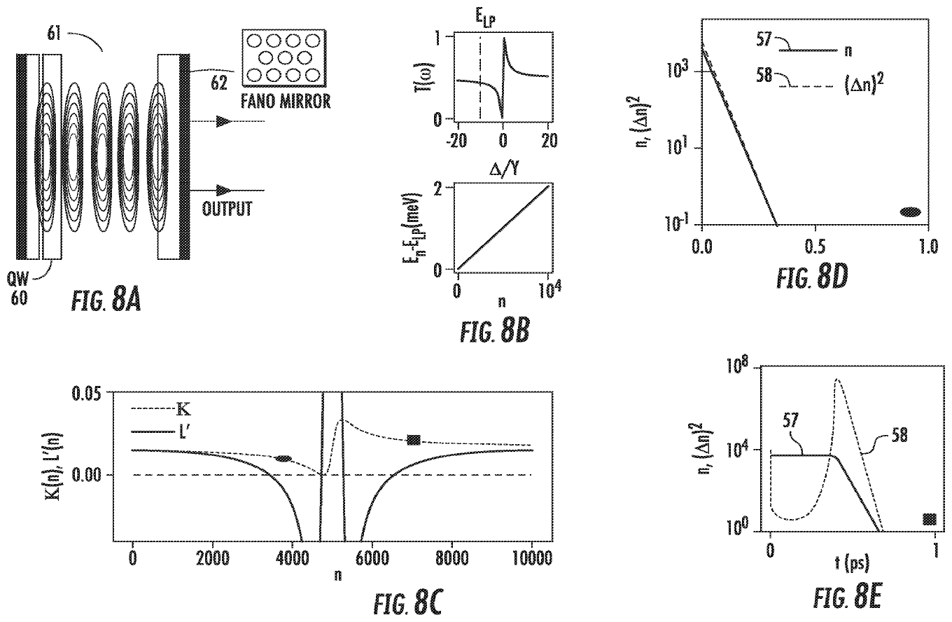

An example of this is shown in FIGS. 8A-8E, for the case in which the nonlinearity in the cavity arises from exciton polaritons, as described previously. FIG. 8A shows a system of excitons in a quantum well (QW) 60, that is strongly coupled to a resonant cavity 61 in which one end-mirror 62 is sharply frequency-dependent. The strong coupling of the excitons to the cavity 61 leads to polaritons, which inherit a strong Kerr nonlinearity due to excitonic Coulomb interactions. FIG. 8B shows the transmission profile and nonlinearity of the lower polariton. The transmission is plotted in terms of the detuning δ. FIG. 8C shows the Loss κ(n)=L(n)/n and its loss-derivative dL/dn for the transmission profile shown in FIG. 8B and polaritons with Kerr nonlinear strength 10⁻⁷ω_{LP}. The detuning of the mirror 62 from the lower polariton energy (with zero polaritons) is 10⁻³ω₀ and the mirror has a sharpness of 10⁻⁴ω_{LP}.

FIGS. 8D and 8E shows the mean 57 and variance 58 of the photon number distribution for two different initial coherent states to the left and right of the approximate zero of κ. The state starting with lower photon number (FIG. 8D) stays effectively coherent while the state with large coherent number (FIG. 8E) has its noise condense to a value 1000-fold below the shot noise limit.

Taking β=10⁻⁷ (at 1.47 eV), γ=1×10⁻⁴ ω₀ (ℏω₀=1.47 eV) and δ=0.35 THz, and considering a sharp loss induced by a Fano mirror, as was described in connection with FIG. 5, it was found that a state with initially less than 4500 photons decays to a Poissonian state, while a state with more photons decays to a near Fock state (noise reduction of >99.9%, Fano factor F<0.001).

FIGS. 9A-9E shows the results when a different set of parameters are used with the system shown in FIG. 8A. In this embodiment, β=5×10⁻⁷; κ=10⁻⁵; γ=5×10⁻⁴; ω_{d}=(1+δ) with δ=10⁻³ in units of the lower polariton frequency, 1.47 eV.

FIG. 9A shows the temporal loss coefficient of the cavity mode a, as a function of photon number in a, associated with the frequency-dependent mirror and nonlinear element. In this system, η₀ is defined as 1000. FIGS. 9B-9C show the operation of the system when the mean photon number is less than η₀. Note that the case where η̅ₒ̅(0)<η₀ does not lead to any noise reduction. After becoming slightly super-Poissonian, the statistics become Poissonian as the amplitude decays to zero. In contrast, when η̅ₒ̅(0)>η₀, as shown in FIGS. 9D-9E, the variance decays much faster than the mean (see FIG. 9E), ultimately approaching a Fock state of η₀=1000 photons. This can be seen in the insert of FIG. 9D.

Further, it is important to understand that, due to the “one way” nature of loss, residual linear loss, as well as any external effects that cause coupling to lower-photon number states, will destabilize the trapped state and limit the noise condensation. However, even when there is no longer a zero of the loss, heavily sub-Poissonian states can result, provided that the distribution falls through a region where the loss is sharply increasing.

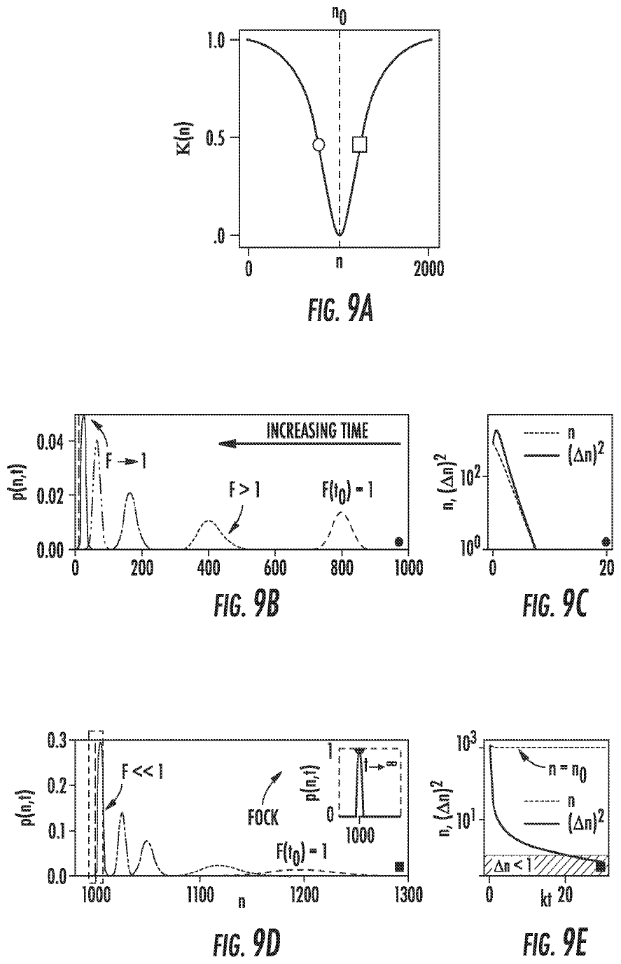

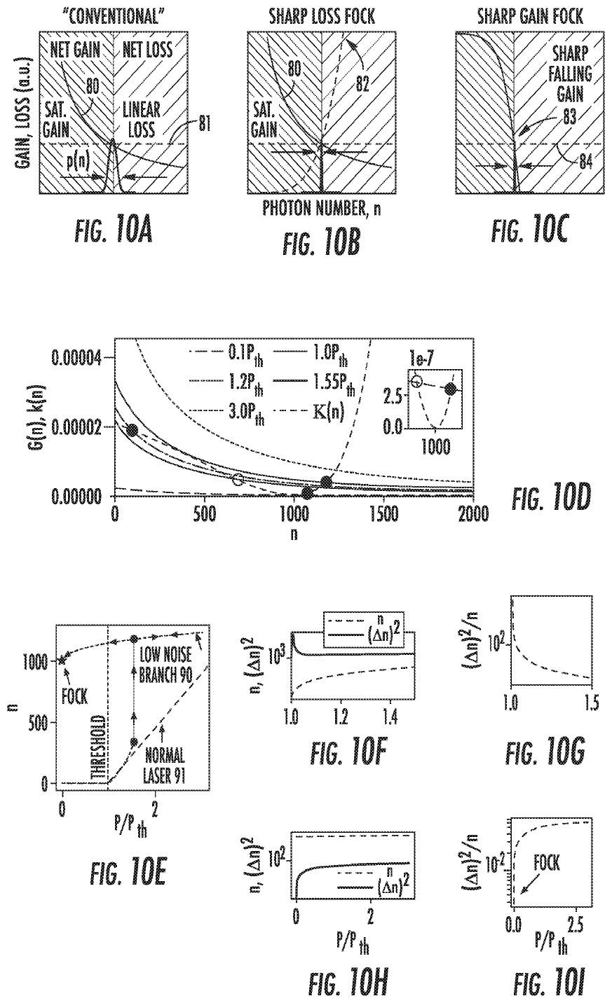

FIGS. 10A-10I show the results when a different set of parameters are used with the system shown in FIG. 2A. The cavity leakage is in the form shown in FIG. 9A. In this embodiment, β=5×10⁻⁵; κ=10⁻⁵; γ=2×10⁻³; ω_{d}=(1+δ) with δ=0.04 in units of the lower polariton frequency, ω_{LP}, which corresponds to an energy of 1.47 eV.

FIG. 10A shows the saturable gain 80 and linear loss 81 associated with a conventional laser, which leads to Poissonian photon statistics well above threshold. FIG. 10B shows a saturable gain 80 combined with a sharply rising loss 82, which leads to condensation of the photon probability distribution. FIG. 10C shows that the same condensation also applies when the gain 83 sharply decreases and the loss 84 is linear.

FIG. 10D shows the gain (temporal gain coefficient for α) and loss curves (temporal loss coefficient for a) for a Fock laser for different values of pump intensity. Generally, stable equilibriums exist at value of η̅ where G(η̅)=κ(η̅) and G(η̅⁺)<κ(η̅⁺). This may result in multiple equilibriums and stable lasing equilibriums with finite photon number even when the pump is below the threshold. Specifically, at a pump strength above the threshold (Pth), the mean photon number increases linearly with pump strength and the noise is substantially higher than the Poisson level. At a certain pump intensity, the system discontinuously jumps to a new steady state with a much larger photon number, as well as very low noise (about 95% lower than the standard quantum limit expected from an ideal laser).

FIG. 10E shows the mean value of the intracavity photon number as a function of pump strength, relative to a threshold. If the system starts from the “low noise branch” 90 and the pump intensity is lowered, the system will follow the upper line. As the pump intensity goes to zero, the stable equilibrium approaches the zero-loss point, as shown in the inset of FIG. 10D.

FIGS. 10F-10I shows the mean and variance, as well as the Fano factor for the two branches of the input-output curve of FIG. 10E. Specifically, FIG. 10F shows the mean and variance of the normal laser branch 91, while FIG. 10G shows the corresponding Fano factor for that branch. FIG. 10H shows the mean and variance of the low noise branch 90 and FIG. 10I shows the Fano factor for that branch. Note that the Fano factor approaches 0 for the low noise branch 90.

Above a threshold pump strength, the mean photon number increases linearly with pump strength, and the noise is substantially higher than the Poisson level, as expected for a laser weakly above threshold. At a certain intensity (here, about 1.55× the threshold pump intensity) the system discontinuously jumps to a new steady state with much larger photon number, as well as very low noise (about 95% lower than the standard quantum limit expected from an ideal laser). If the system is started from this “low noise branch” 90 and then the pump intensity is lowered, the system will follow the top curve in FIG. 10E, and, as the pump goes down to zero, the stable equilibrium approaches the zero-loss point (see inset of FIG. 10D). This point is accompanied by a low noise equilibrium state, which tends to a Fock state as the zero of the loss is approached. For example, for a pump strength of 0.01× the threshold pump intensity, the noise is 20 dB below the shot noise level, and the photon number uncertainty is roughly 3.

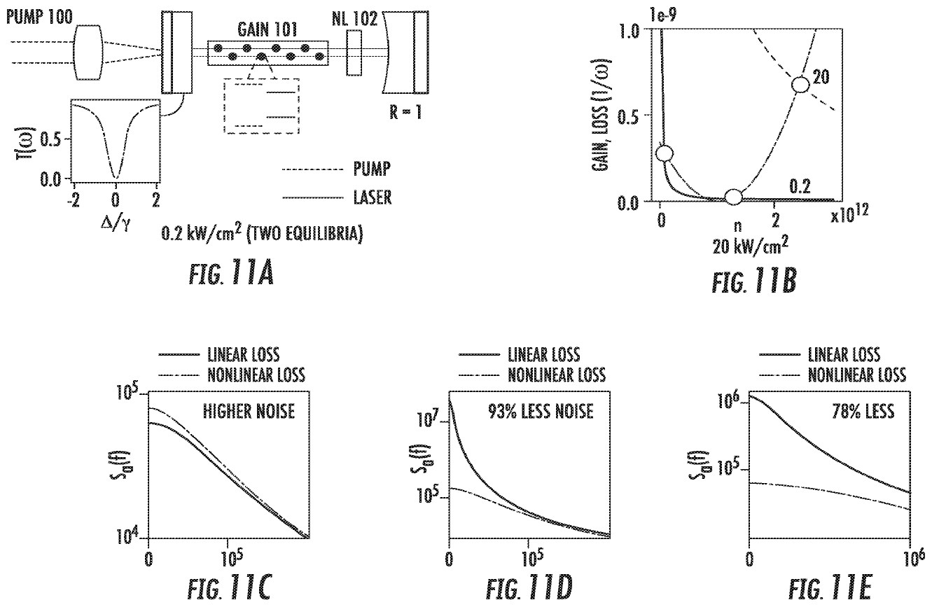

FIGS. 11A-11E show a Fock laser and the results when a different set of parameters are used with this laser. FIG. 11A shows a Fock laser based on a diode pumped solid-state laser 100 with a sharply varying transmissive element 101 and a nonlinear crystal 102. In this system, β=5×10⁻¹⁸; κ=8×10⁻⁵; γ=10⁻²; ω_{d}=(1+δ) with δ=−10−5 in units of the lasing frequency, 1.17 eV.

FIG. 11B shows the gain-loss diagrams with circles representing the stable equilibriums for different pump intensities. FIGS. 11C-11E show the cavity amplitude-noise spectra as a function of frequency for different pump intensities (intensities of the pump excitation laser (here at 808 nm wavelength). The integral of the cavity amplitude-noise spectrum over frequencies gives the uncertainty in cavity photon number, with uncertainties below the square-root of the mean indicating sub-Poissonian light. For intermediate pump intensities, the overall noise reduction can be nearly 95% of the shot-noise limit with 10¹² photons.

The present system has many advantages in a variety of applications.

For example, because the Fock states produced here have minimal uncertainty in their intensity, they can be used to perform spectroscopy without shot noise. This limits the noise without compromising the signal since the Fock states are macroscopic here.

In another application, Fock states could also be used to communicate with light. Because of their low noise, the error rate for a bit would be minimal since the intensity of the communication pulses would not have any uncertainty.

In yet another application, Fock states are considered as an important resource for quantum computers based on manipulating light.

Additionally, small Fock states (at microwave frequencies) are used as a resource to perform quantum simulation of chemical properties of molecules, such as vibronic spectra. Such techniques could also be extended using optical Fock states of similar size, and large Fock states could enable the simulation of highly-excited states of molecules that could not be simulated with the best computers today.

Finally, Fock states can be manipulated to generate other quantum mechanical states which are of interest in the above applications, especially computation and simulation.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. An apparatus for the generation of sub-Poissonian states of radiation at optical and infrared frequencies, comprising:
a pump;
a gain medium; and
a cavity;
wherein apparatus exhibits a sharp frequency dependent gain or loss.

2. The apparatus of claim 1, further comprising an absorbing medium, which or absorbs strongly at optical infrared frequencies, wherein the gain medium, the absorbing medium, or the cavity exhibits a sharp frequency dependent gain or loss.

3. The apparatus of claim 1, wherein the gain medium comprises one or more of the following:
a. a solid-state gain medium (such as YAG, YAP, LuAG, YVO₄, KGW with Nd, Er, Tm, Yb, or other rare-earth dopants), Ti:Sapphire, Ruby
b. a gain medium based on a semiconductor such as GaAs, AlGaAs, GaInAsP, InP, InGaAs, GaN or one or multiple quantum wells
c. a gain medium based on quantum dots
d. a gain medium based on dyes such as rhodamine-6G; and
e. gases such as He-Ne mixtures or CO₂.

4. The apparatus of claim 1, wherein the cavity comprises a nonlinear cavity.

5. The apparatus of claim 4, wherein the nonlinear cavity comprises a cavity formed by two mirrors, the two mirrors having any geometry (e.g., a planar Fabry-Perot cavity, a confocal or semi-confocal cavity, a spherical or hemi-spherical cavity, or an unstable resonator).

6. The apparatus of claim 1, wherein the sharp frequency dependent loss is realized by an optical filter.

7. The apparatus of claim 6, wherein the optical filter comprises at least one of notch, edge, band-pass filters or more general filter shapes that may be realized based on thin films, coupled resonances, Fano resonances, (surface and volume) diffraction (Bragg) gratings, fiber gratings, and bistable optical systems.

8. The apparatus of claim 6, wherein a sharpness of the optical filter at some frequency, ω, is at least 1 part in 10², 10³, 10⁴, 10⁵, or 10⁶, wherein the sharpness is defined as Δω/ω, where Δω is defined as a frequency deviation from ω required for a transmission of the optical filter to double.

9. (canceled)

10. (canceled)

11. (canceled)

12. (canceled)

13. (canceled)

14. The apparatus of claim 1, wherein the cavity comprises a nonlinear energy spectrum.

15. The apparatus of claim 14, wherein the nonlinear energy spectrum is realized by inserting a Kerr nonlinear medium into the cavity.

16. The apparatus of claim 15, wherein the Kerr nonlinear medium comprises GaAs, Ge, ZnTe (and general semiconductors), Si, Si₃N₄, GaP, silica, chalcogenide glasses such as As₂S₃ or As₂Se₃, nonlinear gases such as CS₂, saturable absorbing media (such as Cr:YAG), or polymers such as PTS or DDMEBT.

17. The apparatus of claim 14, wherein the nonlinear energy spectrum is realized by inserting fifth-, seventh-, or higher-order nonlinear medium into the cavity.

18. The apparatus of claim 14, wherein the nonlinear energy spectrum is realized by the nonlinear coupling excitons to a cavity in the strong coupling regime, where the exciton-cavity coupling exceeds the dissipation rates of the exciton and cavity separately.

19. The apparatus of claim 14, wherein the nonlinear energy spectrum is realized by coupling two levels of a quantum system, such as an atom or molecule or artificial atom such as a quantum dot or quantum well, to the cavity such that the coupling is in the dispersive strong-coupling regime, such that the detuning of the quantum system and cavity is larger than their dissipation rates.

20. The apparatus of claim 1, wherein the gain medium exhibits the sharp frequency dependent gain.

21. The apparatus of claim 1, wherein a semiconductor or insulating material is placed in the cavity, wherein the semiconductor or insulating material is operated near the band-edge to create the sharp frequency dependent gain.

22. The apparatus of claim 1, wherein a nonlinear crystal is disposed within the cavity, wherein the nonlinear crystal in conjunction with the gain medium together realize an effectively sharp gain.

23. The apparatus of claim 1, wherein at least one frequency dependent mirror is disposed in the cavity, wherein the frequency dependent mirror causes the cavity to exhibit a sharp frequency dependent loss.

24. An apparatus for the generation of sub-Poissonian states of radiation at optical and infrared frequencies, comprising:
a cavity; and
a source of pump radiation to populate the cavity with an initial number of photons;
wherein apparatus exhibits a sharp frequency dependent gain or loss.

25. The apparatus of claim 24, further comprising an absorbing medium, which absorbs strongly at optical or infrared frequencies, wherein the absorbing medium, or the cavity exhibits a sharp frequency dependent gain or loss.

26. The apparatus of claim 24, wherein the cavity comprises a nonlinear cavity.

27. The apparatus of claim 26, wherein the nonlinear cavity comprises a cavity formed by two mirrors, the two mirrors having any geometry (e.g., a planar Fabry-Perot cavity, a confocal or semi-confocal cavity, a spherical or hemi-spherical cavity, or an unstable resonator).

28. The apparatus of claim 24, wherein the sharp frequency dependent loss is realized by an optical filter.

29. The apparatus of claim 28, wherein the optical filter comprises at least one of notch, edge, band-pass filters or more general filter shapes that may be realized based on thin films, coupled resonances, Fano resonances, (surface and volume) diffraction (Bragg) gratings, fiber gratings, and bistable optical systems.

30. The apparatus of claim 28, wherein a sharpness of the optical filter at some frequency, ω, is at least 1 part in 10², 10³, 10⁴, 10⁵, or 10⁶, wherein the sharpness is defined as Δω/ω, where Δω is defined as a frequency deviation from ω required for a transmission of the optical filter to double.

31. (canceled)

32. (canceled)

33. (canceled)

34. (canceled)

35. (canceled)

36. The apparatus of claim 24, wherein the cavity comprises a nonlinear energy spectrum.

37. The apparatus of claim 36, wherein the nonlinear energy spectrum is realized by inserting a Kerr nonlinear medium into the cavity.

38. The apparatus of claim 37, wherein the Kerr nonlinear medium comprises GaAs, Ge, ZnTe (and general semiconductors), Si, Si₃N₄, GaP, silica, chalcogenide glasses such as As₂S₃ or As₂Se₃, nonlinear gases such as CS₂, saturable absorbing media (such as Cr:YAG), or polymers such as PTS or DDMEBT.

39. The apparatus of claim 36, wherein the nonlinear energy spectrum is realized by inserting fifth-, seventh-, or higher-order nonlinear medium into the cavity.

40. The apparatus of claim 36, wherein the nonlinear energy spectrum is realized by the nonlinear coupling excitons to a cavity in the strong coupling regime, where the exciton-cavity coupling exceeds the dissipation rates of the exciton and cavity separately.

41. The apparatus of claim 36, wherein the nonlinear energy spectrum is realized by coupling two levels of a quantum system, such as an atom or molecule or artificial atom such as a quantum dot or quantum well, to the cavity such that the coupling is in the dispersive strong-coupling regime, such that the detuning of the quantum system and cavity is larger than their dissipation rates.

42. The apparatus of claim 24, wherein a semiconductor or insulating material is placed in the cavity, wherein the semiconductor or insulating material is operated near the band-edge to create the sharp frequency dependent gain.

43. The apparatus of claim 24, wherein at least one frequency dependent mirror is disposed in the cavity, wherein the frequency dependent mirror causes the cavity to exhibit a sharp frequency dependent loss.

44. The apparatus of claim 24, wherein the apparatus exhibits a sharp frequency dependent loss and no gain.

45. The apparatus of claim 24, wherein the apparatus exhibits a sharp frequency dependent loss and a non-frequency dependent gain.
